(19) United States
(12) Patent Application Publication
(10) Pub. No.: US 2004/0013282 A1
(43) Pub. Date: Jan. 22, 2004

(54) ELECTROMAGNETIC LINEAR MOTOR FOR LOUDSPEAKERS AND THE LIKE

(76) Inventor: C. Ronald Coffin, Topsfield, MA (US)

Correspondence Address: George A. Herbster, Esq., Suite 303, 40 Beach Street, Manchester, MA, 01944, US

(21) Appl. No.: 10/196,451

(22) Filed: Jul. 16, 2002

(51) Int. Cl. H04R 1/00; H04R 9/06; H04R 11/02

(52) U.S. Cl. 381/396; 381/412; 381/401

(57) ABSTRACT

An electronic linear motor particularly for use with loudspeakers includes first and second structures that define first and second annular counterfacing air gaps centered on a motor axis. An armature carries first and second voice coils in the first and second annular air gaps, respectively. A spider acts as a centering structure and attaches to the armature and the motor frame to center the armature radially on and longitudinally along the motor axis. A rigid link connects the armature and an output device whereby the armature is constrained to motion along the motor axis without radial displacement with respect to the motor axis.

### BACKGROUND OF THE INVENTION

1. Field of the Invention

This invention generally relates to electromagnetic linear motors and more specifically to such motors adapted for use with electro-acoustical transducers such as loudspeakers.

2. Description of Related Art

Electromagnetic linear motors produce reciprocating motion along an axis in response to alternating current signals applied to a coil structure lying in a magnetic air gap. Changing the amplitude of such alternating current signals causes the coil to reciprocate in the air gap. There are a wide variety of applications for such electromagnetic linear motors.

Loudspeakers represent one application in which electromagnetic linear motors drive loudspeaker cones. In such applications permanent magnets' mount on a motor frame with pole pieces to define an annular magnetic air gap. A voice coil assembly with a bobbin or like structure positions a voice coil in the magnetic air gap and attaches to the speaker cone. An alternating current signal applied to the voice coil oscillates or reciprocates the voice coil assembly and the attached loudspeaker cone along a loudspeaker axis. The resulting speaker cone vibrations should vary in accordance with the frequency and amplitude of the applied alternating current signal for accurate sound reproduction.

In recent years it has become desirable to increase the power ratings for loudspeakers in order to produce sound that more closely matches an input signal by minimizing distortion and improving frequency response particularly in the bass frequency range. One approach is building loudspeakers that are physically larger and use larger electromagnetic linear motors. As these motors become larger, they become more expensive to manufacture. Moreover, the availability of components for loudspeaker motors that utilize coil sizes greater than approximately four inches is limited. It is difficult to manufacture such magnets and incorporate them in electromagnetic linear motors such as used in loudspeaker applications.

Some loudspeakers now use dual tandem voice coils in an attempt to increase power capacity. In these loudspeakers a common bobbin carries two voice coils that ride in two annular magnetic air gaps. These voice coils are stated to operate in a push-pull configuration. It is also stated that the two-segment voice coils allow a high excursion with accuracy and controlled motion.

Other constructions for increasing the power capability of loudspeakers also involve two different voice coils. For example U.S. Letters Pat. No. 5,740,265 (1998) to Shirakawa discloses a loudspeaker unit with a magnet system having dual magnetic air gaps and a vibratory system formed with a cylindrical voice coil bobbin carrying first and second voice coils for use in the dual magnetic gaps respectively. U.S. Letters Pat. No. 5,748,760 (1998) discloses a similar structure in which a magnetic structure includes a neodymium magnet and corresponding pole structures to define an elongated air gap that interacts with two voice coils.

Dual voice coils have also been used for other purposes. For example U.S. Letters Pat. No. 4,176,249 (1979) to Inanaga et al. discloses a loudspeaker with a first magnet structure and voice coil for driving a speaker cone. A second magnet drive and independent voice coil eliminate the effect of reaction forces. U.S. Letters Pat. No. 5,828,767 (1998) to Button discloses a loudspeaker with dual voice coils and a single short-circuited braking coil of one or more turns mounted on the voice coil form midway between the two voice coils. Whenever the voice coil assembly displacement approaches a working limit in either direction, the braking coil enters a corresponding one of two magnetic air gaps and limits motion.

U.S. Letters Pat. No. 4,692,999 (1987) to Frandsen discloses a multi coil, multi-magnet actuator for reciprocating a read/write head mechanism in a magnetic disk storage system as another electromagnetic linear motor application. In this actuator a bobbin carries two coils in two magnetic fields. This structure constitutes a voice coil motor, or solenoid, in which the two coils are oppositely wound to interact with oppositely directed magnetic fields.

In said electromagnetic linear motor it is important that a voice coil bobbin not contact any of the magnetic pole pieces defining the magnetic air gap. This is especially true in loudspeakers constructed to allow large voice coil excursions in the air gap. In these situations it is necessary either to constrain the motion of the voice coil or to increase the air gap to accommodate any motion of the voice coil bobbin off a central axis. However, prior art approaches introduce other issues. For example, the U.S. Letters Pat. No. 5,740,265 employs spiders proximate each end of the voice coil. While such structures may provide proper alignment, they introduce complexities in the design and assembly of component parts and increase manufacturing costs for such electromagnetic linear motors.

### SUMMARY

Therefore it is an object of this invention to provide an electromechanical linear motor that optimizes efficiency.

Another object of this invention is to provide a loudspeaker with a dual-magnet electromagnetic linear motor.

Still another object of this invention is to provide an electromagnetic linear motor with dual magnetic air gaps and dual voice coils that can operate with high power and provide long linear excursions without requiring excessive air gaps.

Still another object of this invention is to provide a loudspeaker system with a dual magnet, dual-voice coil electromagnetic linear motor.

Yet another object of this invention is to provide a loudspeaker with a dual magnet, dual voice coil electromagnetic linear motor capable of receiving signals at high power.

In accordance with this invention a loudspeaker comprises a loudspeaker frame, a loudspeaker cone, first and second magnet structures and a motor frame. The loudspeaker frame suspends the loudspeaker cone for reciprocal displacement along a loudspeaker axis. The motor frame supports first and second magnet structures on the loudspeaker frame with first and second annular air gaps oriented in a counterfacing relationship and centered on the loudspeaker axis. An armature extends along the loudspeaker axis and positions first and second voice coils in the first and second annular air gaps, respectively. A transverse centering support attaches to the motor frame and armature for centering the voice coils radially and longitudinally along the loudspeaker axis. An axially rigid link connects the armature and the loudspeaker cone. Alternating current applied to the voice coils causes the armature and loudspeaker cone to undergo a corresponding displacement that is constrained to motion along the loudspeaker axis without any radial displacement.

In accordance with another aspect of this invention, an electromagnetic linear motor produces reciprocal motion along a motor axis in response to alternating current signals. It includes a motor frame, first and second magnet structures, an armature and a centering member. The motor frame defines first and second spaced positions and an intermediate position along the motor axis. In this embodiment flanges on the first and second magnet structures at the first and second spaced axial positions define first and second spaced, aligned annular magnetic air gaps concentric with the motor axis. The armature carries first and second voice coils positioned to interact with the magnetic fields in the first and second air gaps, respectively. A centering structure attaches between the motor frame and the armature at a position intermediate the first and second voice coils. The centering structure constrains the armature to reciprocal motion along the motor axis in response to the receipt of alternating current signals in the first and second voice coils.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a perspective view of an assembled electromagnetic linear motor constructed in accordance with this invention;

FIG. 2 is a cross-section taken along lines 2-2 in FIG. 1;

FIG. 3 is an exploded view of the electromagnetic linear motor shown in FIG. 1;

FIG. 4 is a cross-section of the electromagnetic linear motor of FIG. 1 for driving a loudspeaker; and

FIG. 5 is a cross sectional view of an alternative embodiment of the electromagnetic linear motor of FIG. 1.

### DESCRIPTION OF ILLUSTRATIVE EMBODIMENTS

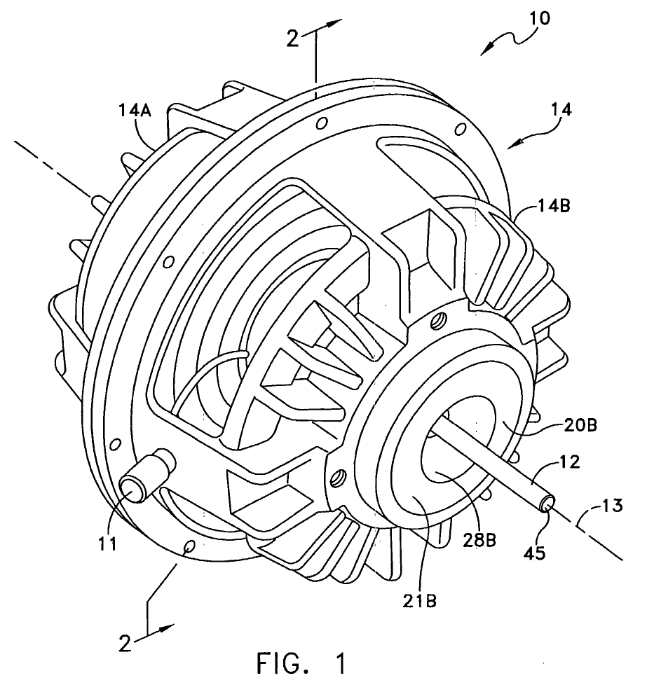

FIG. 1 depicts a electromagnetic linear motor 10 constructed in accordance with this invention. The electromagnetic linear motor 10 converts an alternating current applied to input terminals, one input terminal 11 is shown, to a reciprocating motion of an output device represented by a drive rod 12 that extends along a motor axis 13.

Referring to FIGS. 1 through 3, the electromagnetic linear motor 10 includes a two-piece motor frame 14 with first and second motor frame members 14A and 14B. In the following discussion it will become apparent that the electromagnetic linear motor 10 comprises two identical, but oppositely-facing assemblies. In the orientation of FIGS. 1 through 4, “A” designates an assembly or component on the left side of the figure; “B”, the oppositely oriented, but corresponding assembly or component on the right side of the figure.

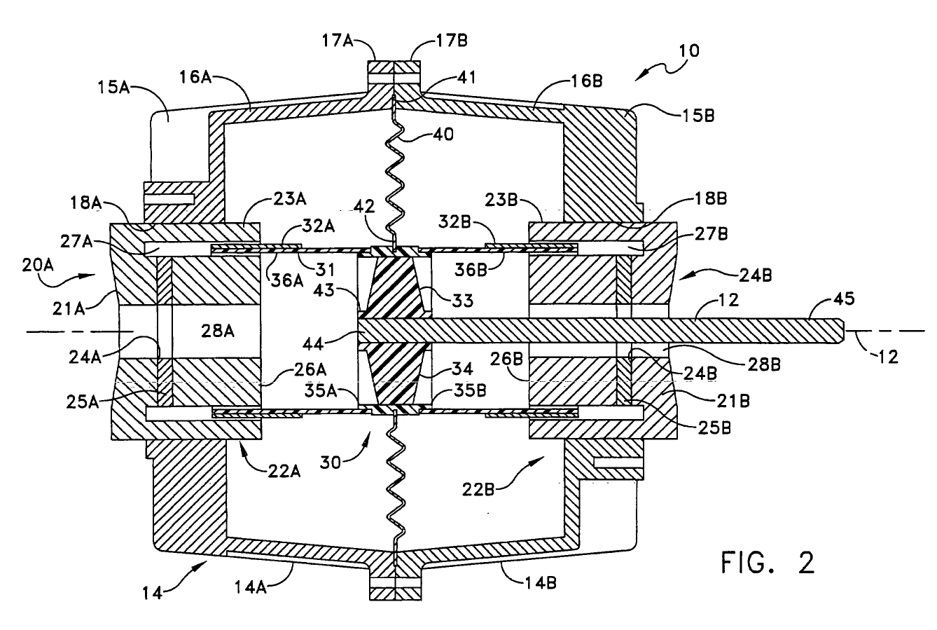

Referring to the motor frame member 14A in FIG. 2, an annular base 15A extends transversely to the motor axis 13. A wall 16A having a generally frusto-conical shape, extends axially to a flange 17A. The annular base 15A terminates in a cylindrical inner wall surface 18A centered on the motor axis 13. The identical, but oppositely facing, motor frame member 14B comprises a base 15B, a wall structure 16B, flange 17B and inner wall surface 18B.

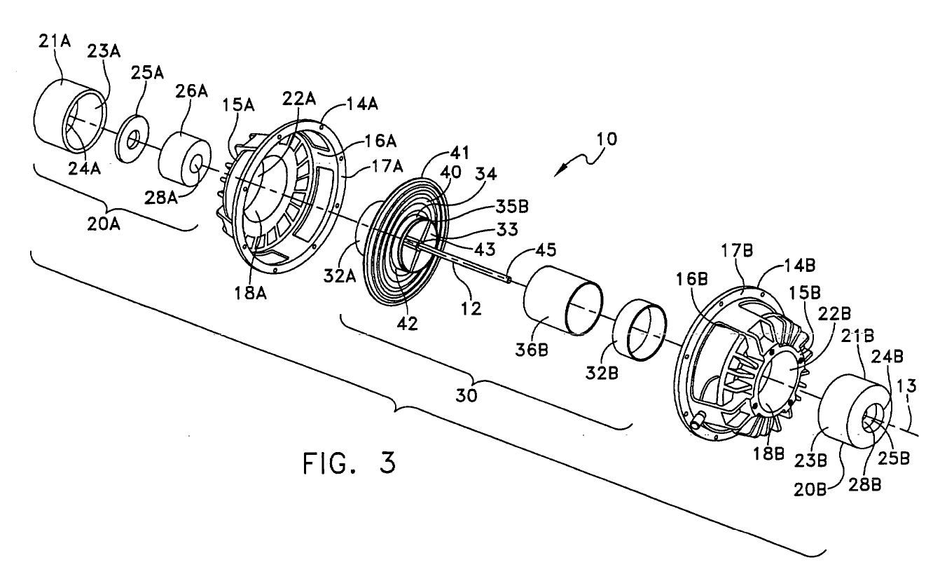

By reference to FIG. 3, it will be apparent that each of the base structures 15A and 15B and the wall sections 16A and 16B can be defined by rib structures for heat dissipation and by spaced axially extending web structures for providing openings for air flow and reducing weight. FIG. 3 depicts a specific implementation. Variations of this implementation are well within the skill of electromagnetic linear motor designers.

The motor frame members 14A and 14B support first and second identically constructed, but counterfacing magnet structures 20A and 20B, respectively. The base 15A supports a cup-shaped annular pole piece 21A that can be press fit or otherwise attached to the base 15A such that it lies in a central opening 22A defined by the surface 18A. A cylindrical wall 23A extends from the base 21A and is concentric with the motor axis 13. An axially elevated platform 24A defines a transverse mounting surface for an annular permanent magnet 25A. Epoxy or another adhesive affixes the permanent magnet 25A to the base 21A. In a preferred embodiment the permanent magnet 25A is a rare earth permanent magnet, such as a neodymium permanent magnet. A cylindrical pole piece 26A affixed to the permanent magnet 25A, completes the magnet structure 20A.

The outer diameters of the permanent magnet 25A and second annular pole piece 26A are less than the inner diameter of the wall 23A thereby to form an axially extending annular air gap 27A. In addition, each of the pole pieces 21A and 26A and the permanent magnet 25A have an annular shape. Consequently the magnet structure 20A has a central passage 28A that lies on and along the motor axis 13. The magnet structure 20B comprises like components 21B through 26B in identical arrangement with an air gap 27B and a central passage 28B.

Thus, the motor frame 14 defines first and second spaced positions coextensive with the bases 15A and 15B and an intermediate position at the mating surfaces of the flanges 17A and 17B. The first and second annular magnet structures 20A and 20B attach to the motor frame 14 at the two axially spaced positions to define a first and second spaced, aligned, annular magnetic air gaps 27A and 27B that are counterfacing and that are concentric with the motor axis 13. Each magnet structure comprises a first annular pole piece supported by the corresponding frame member, such as the pole piece 21A, to define a radially outer surface of the air gap. One side of an annular permanent magnet, like the permanent magnet 25A, abuts the first pole piece 21A. An annular second pole piece 26A abuts the other side of the permanent magnet 25A and extends along the motor axis and forms an inner air gap surface.

The electromagnetic linear motor 10 also includes an armature that is concentric with the motor axis 13. In the particular embodiment shown in FIGS. 2 and 3, the armature 30 includes a bobbin structure 31 and axially spaced voice coils 32A and 32B. More specifically, the armature 30 also includes a cylindrical central hub 33 has a central axially extending, circumferential outer body portion 34 with two cylindrical shoulders 35A and 35B at the opposite ends of the body portion 34. Oppositely extending cylindrical supports 36A and 36B extend axially in opposite directions from the shoulders 35A and 35B, respectively. The opposite ends of the cylindrical supports 36A and 36B carry portions of the voice coils 32A and 32B in the respective air gaps 27A and 27B. The voice coils 32A and 32B connect electrically in series or parallel and to external electrical connections represented by the connection 11 shown in FIG. 1. The formation and connection of the voice coils to a source of alternating current signals is well known to those of skill in the art.

In accordance with this invention, a centering support in the form of a spider 40 establishes the neutral position and locates the armature 30 radially so the voice coils 32A and 32B reciprocate without contacting the pole pieces, such as the pole pieces 23A and 26A. The flanges 17A and 17B clamp an outer periphery 41 of the spider 40. An inner periphery 42 attaches the hub body portion 34 of the armature 30, so the spider 14 is located in a plane normal to the motor axis 13. As known, a spider is a circular piece of fabric or other material with multiple pleats. In the electromagnetic linear motor 10 the spider 40 acts like a spring that returns the voice coil back to its neutral or resting position. In addition, the spider 40 also constitutes an element for radially centering the voice coils 32A and 32B with respect to the motor axis 13A even during axial displacement from the neutral position.

The drive rod 12 transfers the reciprocating motion of the armature 30 to any output device that lies exteriorly to the frames 17A and 17B. The drive rod 12 constitutes a rigid link between the annular bobbin formed by the hub 33 and cylindrical supports 36A and 36B and an output device. As will become apparent, the drive rod 12 also maintains the concentric relationship between the cylindrical supports 36A and 36B and motor axis 13.

More specifically, the hub 33 includes a central cylindrical sleeve 43 that connects to the body portion 34 by means of angularly spaced radial arms 44. With this structure the hub 33 is easily molded from plastics or other materials. The sleeve 43 receives one end 44 of the drive rod 12 that extends along the motor axis 13 to an opposite end 45 that is positioned outside the electromagnetic linear motor 10. FIG. 2 depicts a electromagnetic linear motor 10 with a single drive rod 12 extending to the right. As will now be apparent, a single drive rod could extend to the left of the electromagnetic linear motor 10 shown in FIG. 2. Alternatively the hub 33 could carry two oppositely extending drive rods.

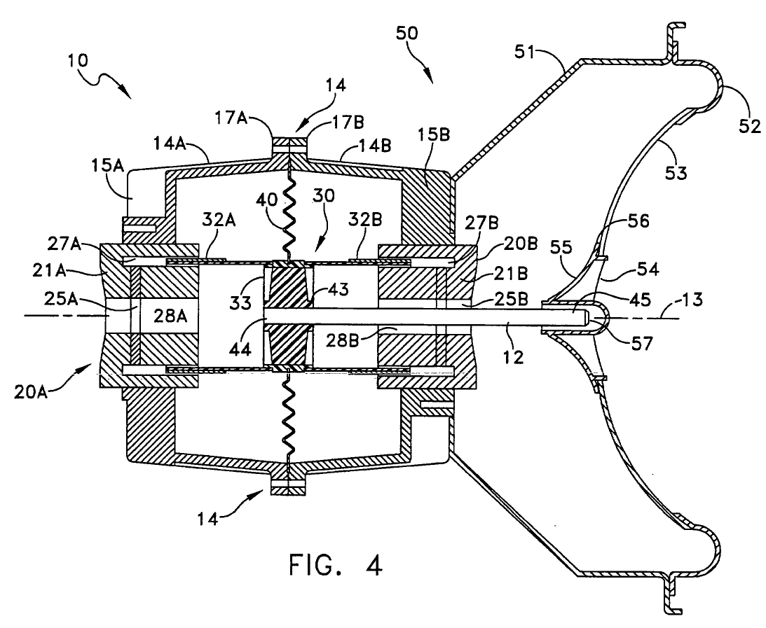

FIG. 4 depicts the electromagnetic linear motor 10 as a driver for a loudspeaker 50 that includes a loudspeaker basket or frame 51. A surround 52 attaches an outer periphery of a speaker cone 53 to the loudspeaker frame 51 so the speaker cone is centered on and is transverse to the motor axis 13 an can be displaced along the motor axis. In this application the motor axis and loudspeaker axis are coincident so in the following discussion related to FIG. 4, the axis 13 is referred to as the loudspeaker axis.

In FIG. 4 the loudspeaker 50 includes an electromagnetic linear motor 10 with motor frames 14A and 14B that support the first and second magnet structures 20A and 20B with first and second annular air gaps 27A and 27B in a counterfacing, aligned relationship and centered on the loudspeaker axis 13. An armature 30 extends along the loudspeaker axis 13 and positions first and second voice coils 32A and 32B in the annular air gaps 27A and 27B respectively. The spider 40 constitutes a centering support that is transverse to the loudspeaker axis 13 and that is attached to the motor frame 14 between the motor frames 14A and 14B. The spider 40 centers the bobbin radially on the loudspeaker axis 13 and longitudinally along the loudspeaker axis 13. The drive rod 12 constitutes an axially rigid link that connects the armature 30, specifically the bobbin structure 31 and the loudspeaker cone 53.

Loudspeaker cones can be annular in shape or can span the axis. In this particular embodiment, the loudspeaker cone 53 has a central portion in the form of a central opening that attaches to a fitting 54. The fitting 54 has a body 55 with an outer periphery 56 attached to the inner periphery of the speaker cone 53. The fitting 54 additionally includes a central cavity 57 that receives the end 45 of the drive rod 12. Adhesive or other means can be used to affix the end 45 in the cavity 57. Thus the drive rod 12 connects the bobbin structure 31 and the loudspeaker cone 53 by means of the fitting 54 whereby alternating current applied to the voice coils 32A and 32B causes the loudspeaker cone 53 to undergo a corresponding displacement. Moreover, the armature 30 is constrained to motion along the loudspeaker axis 13 without radial displacement. In addition to the radial constraints provided by the spider 40, the speaker cone 53 and fittings 54 constrain any radial displacement of the drive rod 12 at its end 45. Such displacement, if were to occur, could skew the armature 30 with respect to the loudspeaker axis 13. With this structure, the centering action of the loudspeaker cone minimizes any such deflection and therefore minimizes any potential for skewing the armature 30 within the magnetic air gaps 27A and 27B.

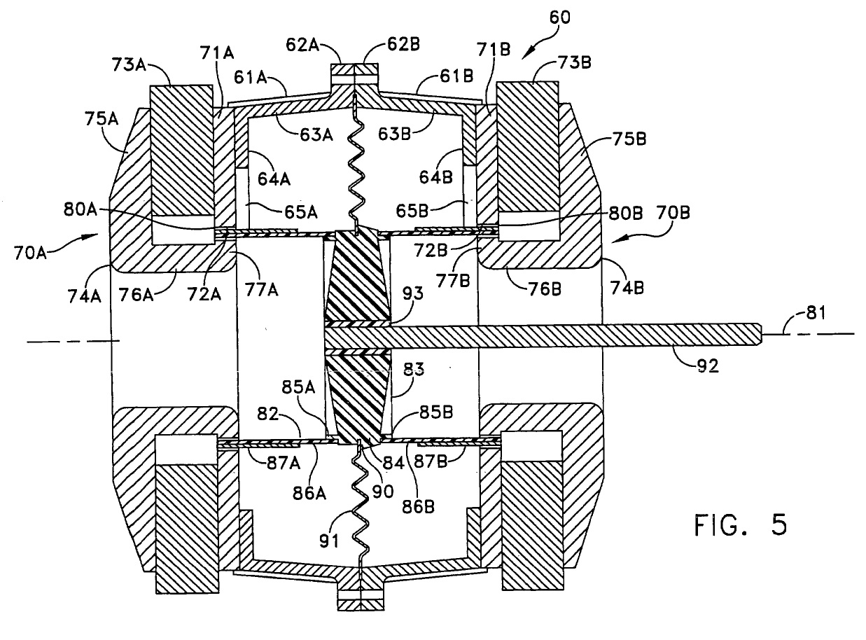

In FIGS. 2 through 4 the magnet assembly includes a permanent magnet located between the pole pieces and isolated from the exterior of the electromagnetic linear motor. FIG. 5 depicts an alternate version of the electromagnetic linear motor 60 that incorporates the basic concepts of this invention but with an external magnet. In this particular embodiment, two cup-shaped motor frame members 61A and 61B form a motor frame. Referring to the motor frame member 61A, an outer annular flange 62A mates with a corresponding flange 62B on the motor frame 61B. An offsetting portion 63A extends to an axially outer, radial mounting flange 64A that defines an annular opening 65A. The mounting flange 64A supports a magnet assembly 70A, particularly an annular, axially inner, pole piece 71A. A circumferential surface 72A defines one boundary of an annular gap.

The first pole piece 71A carries an annular permanent magnet 73A that can be any of the ferrite or rare earth permanent magnet as previously described or even an electromagnet. A second, T-yoke pole piece 74A has first radially extending flange 75 that has a generally cylindrical shape and that abuts the surface of the magnet 73A. A second, axially extending leg 76A defines an annular extension that terminates with a slightly elevated cylindrical surface 77A that forms the an inner boundary for the annular gap. Thus the magnet structure 70A defines an annular magnetic air gap 80A that is concentric with a central motor axis 81. The magnet assembly 70B has a similar structure, and FIG. 5 depicts those components with the same reference numbers as are applied to the magnet assembly 70A, substituting “B” for the suffix.

An armature 82 includes a central hub 83 with an outer circumferential, axially extending body portion 84. The body portion 84 has shoulders 85A and 85B for carrying oppositely extending supports or bobbins 86A and 86B, respectively. The cylindrical supports 86A and 86B carry voice coils 87A and 87B, respectively. The body portion 84 also has a radially extending shoulder 90 that attaches to the inner peripheral portion of a spider 91. The flanges 62A and 62B clamp the outer peripheral portion of the spider 91. A drive rod 92 attaches to a central hub 93 and extends along the motor axis 81.

Thus, like the electromagnetic linear motor 10 shown in FIGS. 2 through 4, the electromagnetic linear motor 60 produces reciprocal motion along a motor axis in response to alternating current signals. Moreover, the motor frames 61A and 61B constitute a structural frame in which the mounting flanges 64A and 64B define first and second spaced axial positions for establishing the magnetic air gaps 80A and 80B that are annular and concentric the motor axis 81. The armature 82 with the cylindrical supports or bobbins 85A and 85B and central hub 83 define an annular bobbin that carries voice coils, such as the voice coils 87A and 87B, at positions that produce interaction with the magnetic fields in the first and second magnetic air gaps 80A and 80B, respectively. The spider 92 constitutes a centering structure that attaches between the motor frame members 61A and 61B at the intermediate portion defined by the abutting surfaces of the flanges 62A and 62B. The flanges 62A and 62B also are positioned intermediate the first and second voice coils 87A and 87B. The spider 92 extends from the flanges 62A and 62B to the armature 82. Thus, the spider 92 constrains the armature 82 to reciprocal motion along the motor axis 81 in response to the receipt of alternating current signals in the first and second voice coils 87A and 87B.

Each of the electromagnetic linear motors disclosed in FIGS. 2 through 5 is a motor that optimizes efficiency particularly in manufacturing. In each embodiment duplicate parts are organized to produce the dual magnetic air gaps. There is a significant commonality of parts, and such a commonality can reduce the overall expenses of manufacture. It has also been found that with this approach significant excursions of the drive rods can be obtained. This is particularly important because each of the electromagnetic linear motors is readily adapted to operate with a loudspeaker, such as shown in FIG. 4.

As will now be apparent, many variations and modifications could be made to the specifically disclosed embodiments of FIGS. 1 through 5 without departing from the spirit and scope of this invention. For example, the outer configurations of the different motor frames 14A and 14B shown in FIG. 1 could be altered while still performing the required functions. The specific configurations and relative spacings shown in FIGS. 2, 4 and 5 can be altered with appropriate changes in the dimensions and layouts of the components shown in those figures. FIG. 3 depicts a particular organization and interrelationship between a number of parts; alternate arrangements could be substituted. Finally, FIG. 4 depicts the application of the electromagnetic linear motor to a simple, single cone loudspeaker system. The application of this motor is adapted for use with a wide variety of loudspeaker systems including single-cone and multiple-cone loudspeakers.

Therefore, it is the intent of the appended claims to cover all such variations and modifications as come within the true spirit and scope of this invention.

What is claimed as new and desired to be secured by Letters Patent of the United States is:

1. A loudspeaker comprising:
A) a loudspeaker basket,
B) a loudspeaker cone suspended from said loudspeaker basket for displacement along a loudspeaker axis,
C) first and second magnet structures that define first and second annular magnetic air gaps, respectively
D) a motor frame supporting said first and second magnet structures on the loudspeaker frame with the first and second annular magnetic air gaps in a counterfacing relationship and centered on the loudspeaker axis,
E) first and second voice coils for being energized by alternating current signals,
F) an armature extending along the loudspeaker axis and supporting said first and second voice coils in the first and second annular magnetic air gaps, respectively,
G) a centering support transverse to the loudspeaker axis and attached to said motor frame and said armature for centering said armature radially on the loudspeaker axis during axial displacement of said armature along the axis, and
H) a rigid link connecting said armature and said loudspeaker cone whereby alternating current applied to said first and second voice coils causes said loudspeaker cone to undergo a corresponding displacement and said armature is constrained to axial motion without radial displacement with respect to the loudspeaker axis.

2. A loudspeaker as recited in claim 1 wherein said motor frame includes first and second frames centered on the loudspeaker axis and extending generally transversely thereto and wherein each of said first and second magnet structures includes:
i) a first, annular pole piece supported by said motor frame to define a radially outer surface of the corresponding magnetic air gap,
ii) an annular permanent magnet having one side in abutment with said first pole piece, and
iii) an annular second pole piece with one surface in abutment with the other side of said annular permanent magnet, a surface of the said second pole piece forming an inner circumferential surface of the corresponding magnetic air gap.

3. A loudspeaker as recited in claim 2 wherein each said annular permanent magnet comprises a ferrite permanent magnet.

4. A loudspeaker as recited in claim 2 wherein each said annular permanent magnet comprises a rare earth permanent magnet.

5. A loudspeaker as recited in claim 2 wherein said armature comprises first and second cylindrical supports for supporting said first and second voice coils, respectively, and a central hub transverse to and centered on the loudspeaker axis for supporting said first and second cylindrical supports on opposite sides of said hub and centered on the loudspeaker axis, said rigid link being connected between said hub and said loudspeaker cone and said centering structure including a spider with an outer periphery attached to said motor frame at the intermediate position and an inner periphery attached to said armature whereby said spider constrains said armature and drive rod to motion along the motor axis in a radially constant position and said drive rod maintains the voice coils concentric with the motor axis.

6. A loudspeaker as recited in claim 5 wherein said loudspeaker cone has an outer periphery and a central portion and wherein a surround attaches said outer periphery to said loudspeaker basket and said rigid link connects to a central portion of said loudspeaker cone.

7. A loudspeaker as recited in claim 1 wherein said armature comprises first and second cylindrical supports for supporting said first and second voice coils, respectively, and a central hub transverse to and centered on the loudspeaker axis for supporting said first and second cylindrical supports on opposite sides of said hub and centered on the loudspeaker axis, said rigid link being connected between said hub and said loudspeaker cone and said centering structure including a spider with an outer periphery attached to said motor frame at the intermediate position and an inner periphery attached to said armature whereby said spider constrains said armature and drive rod to motion along the motor axis in a radially constant position and said drive rod maintains the voice coils concentric with the motor axis.

8. A loudspeaker as recited in claim 7 wherein said loudspeaker cone has an outer periphery and a central portion and wherein a surround attaches said outer periphery to the loudspeaker basket and said rigid link includes a connector affixed to said central portion of said loudspeaker cone.

9. A loudspeaker as recited in claim 1 wherein said first and second voice coils are electrically interconnected.

10. A loudspeaker as recited in claim 1 wherein said centering structure includes a spider with an outer periphery attached to said motor frame at an intermediate position and an inner periphery attached to said hub whereby said spider constrains said armature and rigid link to motion along the motor axis in a radially constant position and said rigid link maintains the voice coils in a concentric relationship with respect to the motor axis.

11. A loudspeaker as recited in claim 1 wherein said loudspeaker cone has an outer periphery and a central portion and wherein a surround attaches said outer periphery to the loudspeaker basket and said rigid link is affixed to said central portion of said loudspeaker cone.

12. An electromagnetic linear motor for producing reciprocal motion along a motor axis in response to alternating current signals comprising:
A) a motor frame defining first and second spaced positions and an intermediate position on the motor axis,
B) first and second annular magnet structures attached to said motor frame at the first and second spaced axial positions to define first and second spaced, aligned annular magnetic air gaps concentric with the motor axis,
C) an armature positioned for reciprocation in said first and second magnetic air gaps along the motor axis, said armature carrying said first and second voice coils to interact with the magnetic fields in said first and second magnetic air gaps, respectively, and
D) a centering structure attached between said motor frame and said armature intermediate said first and second coils whereby said centering structure constrains said armature to reciprocal motion along the motor axis in response to the receipt of alternating current signals in said first and second voice coils.

13. An electromagnetic linear motor as recited in claim 12 wherein said centering structure comprises a spider with an outer periphery attached to said motor frame at the intermediate position and an inner periphery attached to said armature whereby said spider constrains said armature to axial motion along the motor axis in a radially constant position.

14. An electromagnetic linear motor as recited in claim 12 wherein said electromagnetic linear motor drives an output device and additionally comprises a rigid link connected between said armature and the output device to transfer reciprocating motion of said armature resulting from energization of said voice coils to the output device and maintain the orientation of said armature and said voice coils with respect to the motor axis.

15. An electromagnetic linear motor as recited in claim 14 wherein said centering structure comprises a spider with an outer periphery attached to said motor frame and an inner periphery attached to said armature whereby said spider and said link maintain the alignment of said armature along the motor axis during the reciprocal movement of said armature and voice coils.

16. An electromagnetic linear motor as recited in claim 15 wherein said link lies along the motor axis.

17. An electromagnetic linear motor as recited in claim 16 wherein said armature includes a hub mounted transversely to the motor axis and said link comprises a drive rod mounted to said hub and the output device and positioned on the motor axis.

18. An electromagnetic linear motor as recited in claim 14 wherein said motor frame comprises first and second motor frame members, and wherein each of said magnet structures includes:
i) a first, annular pole piece supported by said corresponding motor frame member to define a radially outer surface of the magnetic air gap,
ii) an annular magnet having one side in abutment with said first pole piece,
iii) an annular second pole piece with one surface in abutment with the other side of said annular magnet, a surface of said second pole piece forming an inner, magnetic air gap surface.

19. An electromagnetic linear motor as recited in claim 18 wherein said armature comprises a central hub transverse to the motor axis for supporting first and second oppositely extending cylindrical supports that each carry one of said voice coils, wherein said link to the output device comprises a drive rod connected between said armature and the output along the motor axis and wherein said centering structure comprises a spider with an outer periphery attached to said frame at the intermediate position and an inner periphery attached to said armature whereby said spider constrains said annular hub and drive rod to motion along the motor axis in a radially constant position and said drive rod maintains the voice coils concentric with the motor axis.

20. An electromagnetic motor as recited in claim 18 wherein each said magnet comprises a permanent magnet.

21. An electromagnetic linear motor as recited in claim 18 wherein each said magnet comprises a neodymium permanent magnet.
